(19) United States
(12) Patent Application Publication
(10) Pub. No.: US 2008/0019390 A1
(43) Pub. Date: Jan. 24, 2008

(54) Multi-modal information service

(76) Inventors: Stephen Singh, Westford, MA (US); Eugene Cartright, Pelham, NH (US)

Correspondence Address: PROSKAUER ROSE LLP, ONE INTERNATIONAL PLACE, BOSTON, MA, 02110, US

(21) Appl. No.: 11/488,966

(22) Filed: Jul. 19, 2006

(51) Int. Cl. H04J 3/22

(52) U.S. Cl. 370/465; 370/401

(57) ABSTRACT

Described are methods, systems, and apparatus, including computer program products for providing user selectable multimodal information services. A user is enabled to select a response mode from a plurality of modes associated with a request type. The response mode defines a representation format of information associated with the request type. A request message is received from the user. The request message is capable of having been transmitted by any one of the plurality of modes and is associated with the request type. The selected response mode is determined based on the request message. A response message based on the selected response mode is transmitted.

### FIELD OF THE INVENTION

The present invention relates generally to computer-based methods and apparatuses, including computer program products, for providing user selectable multimodal information services.

### BACKGROUND

Our society is increasingly becoming more interconnected as a result of a wider availability of communication devices, which range from wireless handheld devices to landline and wireless computers. In addition to the increasing number of communication devices exists a similarly increasing number of modes of communication capable of being used by these devices to communicate between one another. Communication modes range from textual modality (e.g., electronic mail or instant messaging) to graphical modality (e.g., still and/or moving pictures) to audio modality (e.g., Voice over Internet Protocol (VOIP)).

The proliferation of new communication devices and modes has allowed service providers new means for communicating and interacting with their customers. For example, customers can access account information using one of their wireless handheld devices. Typically, service providers use a predetermined and fixed mode of communication for providing a customer access to information. Furthermore, if a service provider offers more than one mode of communication to their customers, each mode of communication is handled separately by the service providers' framework for that particular mode.

### SUMMARY OF THE INVENTION

One approach to providing multimodal information is to enable a user to select a response mode. In one aspect, there is a method. The method includes enabling a user to select a response mode from a plurality of modes associated with a request type. The response mode defines a representation format of information associated with the request type. The method also includes receiving a request message from the user. The request message is capable of having been transmitted using any one of the plurality of modes and is associated with the request type. The method also includes determining the selected response mode based on the request message. The method also includes transmitting a response message using the selected response mode.

In another aspect, there is a system. The system includes a multimodal information server. The multimodal information server is adapted to enable a user to select a response mode from a plurality of modes associated with a request type. The response mode defines a representation format of information associated with the request type. The multimodal information server is also adapted to receive a request message from the user. The request message is capable of having been transmitted by any one of the plurality of modes and is associated with the request type. The multimodal information server is also adapted to determine the selected response mode based on the request message. The multimodal information server is also adapted to transmit a response message using the selected response mode.

In other examples, the multimodal information server can include one or more adaptors for interfacing with one or more servers associated with the plurality of modes. The plurality of modes can be based on one or more of an audio mode, a text mode, a graphic mode, a multimedia mode, or any combination thereof. The multimodal information server can include a database adapted to receive and store the selected response mode before the multimodal information server receives the request message. The multimodal information server can include a receiver for receiving a request message from the user, a processor for determining the selected response mode based on the request message, and a processor memory module for storing the request message.

In another aspect, there is a computer program product. The computer program product is tangibly embodied in an information carrier. The computer program product includes instructions being operable to cause a data processing apparatus to enable a user to select a response mode from a plurality of modes associated with a request type. The response mode defines a representation format of information associated with the request type. The computer program product also includes instructions being operable to receive a request message from the user. The request message is capable of having been transmitted by any one of the plurality of modes and is associated with the request type. The computer program product also includes instructions being operable to determine the selected response mode based on the request message. The computer program product also includes instructions being operable to transmit a response message using the selected response mode.

In other examples, any of the aspects above can include one or more of the following features. The plurality of modes can be based on one or more of: an audio mode, a text mode, a graphic mode, a multimedia mode, or any combination thereof. The audio mode can be based on a live voice call or an automated voice call. The automated voice call can be based on interactive voice response (IVR). The text mode can be based on one or more of: electronic mail, text messaging, instant messaging, a universal resource locator (URL) message, a session initiation protocol (SIP) message, or any combination thereof. Text messaging can be based on Short Message Service (SMS). The multimedia mode can be based on one or more of: Multimedia Messaging Service (MMS), Enhanced Messaging Service (EMS), IP Multimedia System (IMS), audio/video broadcasting, or any combination thereof. The user can be enabled to select the response mode by enabling the selected response mode to be embedded in the request message. The selected response mode can be determined based on the request message by extracting the selected response mode from the request message. The user can be enabled to select the response mode by receiving and storing the selected response mode before receiving the request message. The selected response mode can be determined based on the request message by identifying the user based on the request message, and retrieving the selected response mode associated with the user from a database. The selected response mode can be determined based on the request message by identifying a request mode associated with the request message, and retrieving the selected response mode based on the request mode from a database. The request type can be based on one or more of: account information request, news request, market update request, stock quote request, location request, directions request, weather report request, sports report request, new account information request, customer service request, or any combination thereof.

Any of the above implementations can realize one or more of the following advantages. User selectable multimodal information services provides an open architecture allowing any common form of communication protocol, mode, or application to be integrated in the same system. In addition, user selectable multimodal information services allows service providers and/or enterprises to seamlessly evolve with one or more of: the customers own evolving set of requirements, changing demographics, evolving communications products and devices, growing demand, and customers' continuing desire to simplify the process of receiving information. In addition, user selectable multimodal information services allows for personalization of information delivery which can be device independent, on demand, at or near real-time delivery, browserless, and customizable by customer. User selectable multimodal information services can be an industry leading framework that provides customers with timely information in a personalized manner that meets their ever changing lives.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing an exemplary network with devices relating to multimodal information services.

FIG. 2 is a flowchart depicting the setup and delivery of multimodal information services.

FIG. 3 is a block diagram illustrating communication devices implementing multimodal information services.

### DETAILED DESCRIPTION

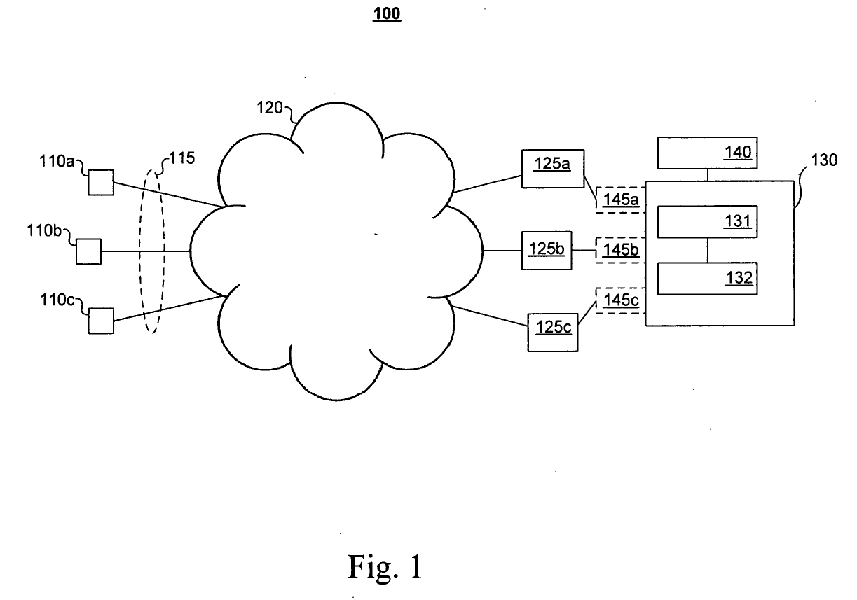

FIG. 1 is a block diagram showing an exemplary network 100 with devices relating to multimodal information services. Multimodal information services involve the transfer of information between two or more users or a user and a system via one or more modes of interaction. Multimodal information services can enhance traditional information services to provide users with a more efficient way to access information and/or interact with an application or service. Multimodal interaction can include textual modality, graphical modality, audio modality, multimedia modality, and/or the like. Textual modality can include, for example, electronic mail, text messaging (e.g., Short Message Service (SMS) or the like), instant messaging, a universal resource locator (URL) message, session initiation protocol (SIP) message, and/or other text-based modalities. Graphical modality can include transfer of still and/or moving pictures. Audio modality can include live voice calls over any network and/or automated voice interaction such as, for example, interactive voice response (IVR). Multimodal communications can also combine any of the above-listed modes of communication. Multimedia Messaging Service (MMS), Enhanced Messaging Service (EMS), and audio/video broadcasting, for example, allow for the transfer of textual, graphical, and/or audio information between users. Multimodal communications can also include using one mode of communication from a first user to a second while using a different mode of communication from the second user to the first user. From example, one user can send a SMS text message to another user who, in response, sends electronic mail back.

The network 100 includes a transmission medium 120 responsible for the transfer of information between two or more points. The transmission medium 120 can include one or more packet-based networks and/or circuit-based networks in any configuration. Packet-based networks can include, for example, the Internet, a carrier internet protocol (IP) network (LAN, WAN, or the like), a private IP network, an IP private branch exchange (IPBX), a wireless network (e.g., a Radio Access Network (RAN)), and/or other packet-based networks. Circuit-based networks can include, for example, the Public Switched Telephone Network (PSTN), a legacy private branch exchange (PBX), a wireless network (e.g., a RAN), and/or other circuit-based networks. The transmission medium 120 can be coupled to a plurality of user devices 110a, 110b, and/or 110c, generally 110, by connections 115. The user devices 110 can be computers, telephones, IP phones, mobile devices (e.g., cellular phones, personal digital assistant (PDA) devices, laptop computers, and/or the like), and/or other communication devices. Connections 115 can include electrical wires, optical fibers, and/or wireless transmissions.

The transmission medium 120 can also be coupled to one or more servers, for example 125a, 125b, and/or 125c, generally 125. The servers 125 can include, for example, web servers, authentication servers, application servers, media servers, gateways, softswitches, and/or the like. Information can be transmitted between user devices 110 and/or servers 125 based on one or more communication protocols and/or communication modes. Communication protocols can include, for example, Internet Protocol (IP), Voice over IP (VOIP), Peer-to-Peer (P2P), Hypertext Transfer Protocol (HTTP), Session Initiation Protocol (SIP), Really Simple Syndication (RSS), podcasting, Signaling System #7 (SS7), Global System for Mobile Communications (GSM), Push-to-Talk (PTT), PTT over Cellular (POC), and/or other communication protocols.

Each server 125 can be responsible for processing messages of a certain type of communication protocol and/or communication mode. For example, a server 125 can be a Simple Mail Transfer Protocol (SMTP) server for handling electronic mail. A server 125 can also be an application server and/or media server for handling interactive voice response (IVR) communications based on, for example, Voice extensible Markup Language (VXML). A server 125 can also be a softswitch, media gateway, IP Multimedia Subsystem (IMS) application server, and/or service switching point (SSP) for handling voice calls based on, for example, SIP or SS7. A server 125 can also be an application server for handling text messaging and/or instant messaging communications. In the system 100, the servers 125 are illustrated to be separate from one another in addition to being directly connected to the transmission medium 120, but other configurations can also be used. For example, one or more servers 125 handling different communication protocols and/or modes can be combined, or one or more servers 125 can be indirectly coupled to the transmission medium 120 by, for example, another server 125 or gateway.

The servers 125 are coupled to a Multimodal Information Server 130 (MIS). The MIS 130 is responsible for processing responses to requests for information sent by the user device 110. In this embodiment, the MIS 130 is directly connected to the servers 125, but other configurations can also be used. For example, the MIS 130 can be directly or indirectly connected to the transmission medium 120 and access the servers 125 through the transmission medium 120. In another configuration, one or more of the servers 125 can be included in the MIS 130. The MIS 130 includes a request/response server 131 and a policy server 132. The MIS 130 can also be coupled either directly or indirectly over the transmission medium 120 to a content server 140. In another configuration, the MIS 130 can include the content server 140. The request/response server 131 is responsible for receiving request messages and transmitting responses messages for each request message. The policy server 132 is responsible for retrieving the appropriate information from the content server 140 corresponding to each request message. The request/response server 131 and/or the policy server 132 can also be responsible for formatting the retrieved information into a response message conforming to a user selected communication protocol and/or communication mode. In this embodiment, the MIS 130 includes both the request/response server 131 and the policy server 132, but other configurations can also be used. For example, the request/response server 131 and the policy server 132 can be located remotely from one another.

The MIS 130 can also optionally include adaptors 145a, 145b, and/or 145c, generally 145. The adaptors 145 serve as an interface between the different types of servers 125 and the MIS 130 to enable the any input any output processing. In some examples, an adaptor (e.g., the adaptor 145a) performs the rendering of the messages for a particular format with which that adaptor is associated. For example, if the adaptor (e.g., the adaptor 145a) is in communication with a cellular mobile phone network, the adaptor would render the message for mobile phone devices. In some examples, one or more of the adaptors 145 are included in the MIS 130. In other examples, one or more of the adaptors 145 are included in one or more of the servers 125.

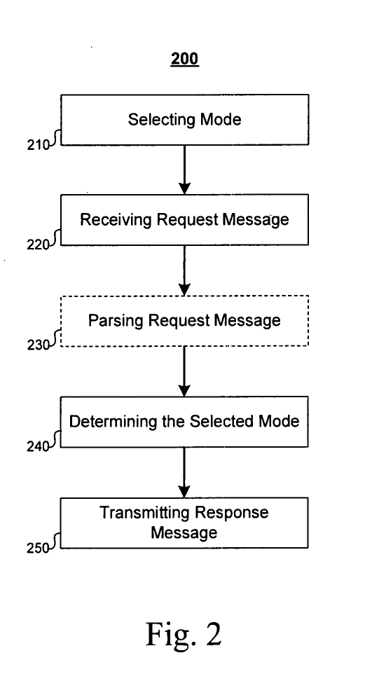

FIG. 2 illustrates a flowchart 200 depicting the setup and delivery of user selectable multimodal information services. The elements of the flowchart 200 are described using the exemplary network 100 of FIG. 1. The setup and delivery of multimodal information services includes user selection of a response communication mode (210), receiving a request message (220), optionally parsing the request message (230), determining the communication mode that was selected by the user for responding to the request message (240), and/or transmitting a response message conforming to the selected communication mode (250). A user selects (210) a communication mode for receiving information associated with one or more request types. The user can request, for example, information of the following types: (personal) account information, news reports, market updates, stock quotes, office and other locations, directions to a specified location(s), weather reports, sports reports, new account information, customer service information, and/or other content. For a specified request type (e.g., stock quotes), the user can select a communication mode (e.g., an SMS text message) for receiving the requested information. The user can also select a specific device (e.g., 110a) for the response message to be transmitted to. In addition, the same user can specify further communication modes (e.g., automated voice calls to their cellular phone) for other request types (e.g., weather reports).

User selection (210) can be performed either before or at the same time a request message is sent. The user can indicate their modal selection within the request message itself, which would not require the user to have an existing account. The user can also notify the MIS 130 of their selection through any means of communication before a request message is sent. For example, using a web browser on their computer (e.g., 110b), the user can make a modal selection by accessing and updating their account profile via a web server (e.g., 125c), or the user can use their phone (e.g., 110c) to call into a live and/or automated voice service center to make their selection. The user's selection information can be stored on a database (not shown) accessible by the policy server 132.

The MIS 130 receives a request message (220) from the user device 110. The request message can be transmitted over the transmission medium 120 using one or more communication protocols and/or communication modes. The request message can be received by one of the servers 125 associated with the one or more communication protocols and/or communication mode of the request message. The server 125 can process and/or parse (230) the request message before forwarding the request message on to the MIS 130. The MIS 130 can also process and/or parse (230) the request message. For example, the request message can be parsed into one or more of the following: header information, timestamp, source destination (e.g., sender's phone number or IP address), protocol identifier, data coding, data length, message, geo-location, or the like. The server 125 and/or the MIS 130 can further parse the request message into one or more of the following: request type (e.g., stock quote), input parameters (e.g., company for which a stock quote is being requested), response mode (e.g., SMS text message), or the like. For example, for voice modality request messages, the server 125 (e.g., a media server) can parse and interpret the incoming voice request message and generate a request message for the MIS 130 indicating a request type, input parameters, and a response mode.

Based on the type of the request message, the policy server 132 determines (240) the response mode selected by the user. If the selected response mode is embedded in the request message itself, the policy server 132 can default to this mode in generating a response message. If the request message does not indicate a response mode, the policy server 132 can perform appropriate data validation on the request message and determine from the user's account if any selection has previously been made with respect to the request type of the request message. The MIS 130 can receive a request message of a certain type (e.g., stock quotes) sent by one or more communication protocols and/or in one or more communication modes, independent of the user's selected mode of response. For example, independent of the user's selection to receive all stock quotes as an SMS text message to their PDA, the user can send the stock quote request message as a SMS text message, an electronic mail, a voice call, or a HTTP request. If the selected response mode is a voice call to the user, and the user is either not reachable (e.g., the mobile device is out of range of a communications tower) or the user's line is busy, the MIS 130 can by default send the response message in a different mode such as an SMS text message. For example, the SMS text message can begin with “We were unable to contact you by phone,” and can include the originally requested information.

Based on the request type, the policy server 132 retrieves the appropriate information from the content server 140 to include in the response message. The policy server 132 and/or the request/response server 131 can generate the response message in the communication mode determined by the policy server 132, or the request/response server 131 can forward the response message to the appropriate server 125 to generate the response message in the selected communication mode. For example, the policy server 132 can generate a text-to-speech file, such as a .wav file, for audio modality responses. In another example, the policy server 132 can initiate an outbound voice call. The request/response server 131 or the server 125 transmits the response message to the user device 110 conforming to the user's selected communication mode (250).

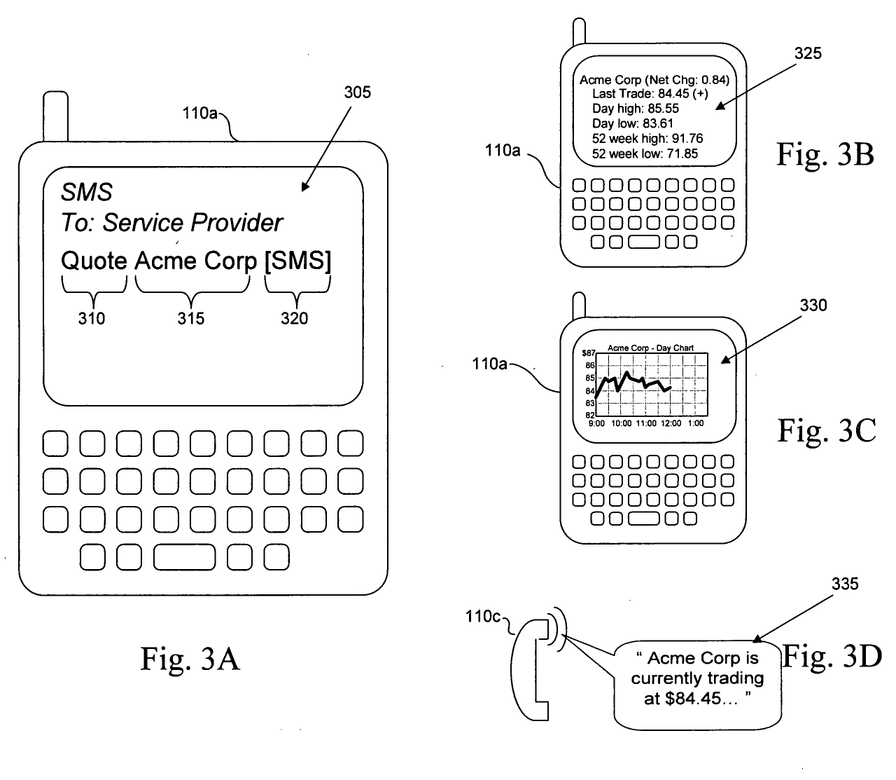

FIGS. 3A-3D are block diagrams illustrating communication devices implementing user selectable multimodal information services. FIG. 3A illustrates a SMS text request message 305 composed on a user's PDA 110a. The request message 305 includes a request type parameter 301, an input parameter 315, and a response mode parameter 320. In the request message 305, the value for the request type parameter 310 is “Quote” and this indicates that the request type is for a stock quote. The value for the input parameter 315 is for “Acme Corp” and this indicates that the request for a quote is for a company named Acme Corp. The value for the response mode parameter 320 is “SMS” and this indicates that the selected response mode by the user is SMS. The use of the response mode parameter 320 enables a user to select the mode of the response to the request message 305, advantageously enabling a real-time selection based on the user's needs and capabilities at that particular period of time.

FIG. 3B illustrates an exemplary SMS text message response 325 received on the user's PDA 110a in response to, for example, the request message 305 of FIG. 3A. Because the mode of SMS was selected by the user, the format of the response 325 is text-based. FIG. 3C illustrates an exemplary response 330 in which a MMS message response mode was selected in the request message. For example, the value for the response mode parameter 320 in such a request message can be “MMS”. The MMS response message 330 can include, for example, pictures and/or text. Because the mode of MMS was selected by the user, the format of the response 330 can be graphical and image-based, as well as including text.

FIG. 3D illustrates an exemplary response 335 in which an audio message response mode was selected in the request message. For example, a VXML response message can be generated by the MIS 130 and executed on an application server 125 and/or media server 125. The server 125 can initiate a voice call to the user device 110c to transmit the requested information. If the user device 110a is capable of handling voice calls, then a voice response can be transmitted to device 110a.

The following table illustrates examples of request messages:

Request Messages

“quotes CompanyX CompanyY”
“quotes CompanyX CompanyY [SMS]”
“quotes CompanyX CompanyY [voice]”
“quotes”
“quotes watchlist”
“watchlist”
“watch CompanyX CompanyY”
“add watch CompanyX CompanyY”
“remove watch CompanyX”
“stop watch CompanyX”
“news CompanyX”
“weather Boston [voice]”

Request messages can include a command indicating a request type. As illustrated in the table, commands can include, for example, quotes, watchlist, watch, add watch, remove watch, stop watch, news, or weather. The quotes command requests, for example, the stock price information for the listed company(s). The watchlist command or the quotes command with no companies listed requests, for example, the stock price information for a list of companies the user has previously defined. The watch, add watch, remove watch, stop watch commands allow the user to define the companies on their watchlist. The news command requests, for example, recent news associated with the listed company(s). The user can further specify a certain time period for which to return news items. The weather command requests, for example, the current weather for the listed city or zip code. At the end of each request message, the user can select, in brackets for example, the response mode that they want to receive the requested information in. If no response mode is indicated, the MIS 130 can retrieve predefined user account information to determine if the user has previously selected a response mode. If a response code is indicated, the MIS 130 can retrieve can retrieve predefined user account information to determine the device to which a response should be sent for a particular mode (e.g., cell phone, home phone, or PDA for a voice response). The MIS 130 can prioritize device and responses, so that if there is no indication a user received a response, the MIS 130 transmits the response again using a different mode and/or device.

Similar to the way response messages can be transmitted using different modes, different channels, and/or different devices, the request messages can also be transmitted using different modes, different channels, and/or different devices. For example, the request messages in the table above can be sent textually via SMS or MMS, or can be spoken by a user through a telephony device. The MIS 130 receives that message through any of those different modes, different channels, and/or different devices, translated using the servers 125, the gateways, and/or the adaptors 145. In addition to determining (240) the response mode based on the type of the request message (e.g., quote, news, etc.), the MIS 130 can also determine the appropriate response mode to a certain request message based on the mode of communication that the request message was sent (e.g., SMS, voice, etc.). For example, the MIS 130 can set the response mode to certain SMS requests to be SMS response messages, and/or the response mode to certain voice call requests to be voice call response messages. The MIS 130 can base the determination of the appropriate response mode on the type of the request message, the mode of the request message, or both the type and mode of the request message.

Users can also transmit request messages for information about opening new accounts. For example, a service provider can advertise to customers: “For more information about the opening an IRA, send a message with the subject “open IRA” to [Service Provider Name].” In response to a received customer request, the service provider can respond by initiating a voice call to the customer. In addition, if the estimated time that a service representative can make a call to the customer is more than a predetermined amount of time (e.g., 2 minutes), the service provider can transmit an SMS message to the customer indicating the estimated amount of time remaining before a service representative can call them. Customer service requests can be handled in a similar fashion.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and the computer program can be deployed in any form, including as a stand-alone program or as a subroutine, element, or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by, and an apparatus can be implemented as, special purpose logic circuitry, e.g., an FPGA (field programmable gate array) or an ASIC (application-specific integrated circuit). Subroutines can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and a server are generally remote from each other and typically interact through a communication network. The relationship of client and server arises by virtue of computer programs running on the respective computers and having a client-server relationship to each other.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes-that come within the meaning and range of equivalency of the claims are therefore intended to be embraced therein.

What is claimed is:

1. A method for providing multimodal information services comprising:
enabling a user to select a response mode from a plurality of modes associated with a request type, the response mode defining a representation format of information associated with the request type;
receiving a request message from the user, the request message capable of having been transmitted using any one of the plurality of modes, the request message associated with the request type;
determining the selected response mode based on the request message; and
transmitting a response message using the selected response mode.

2. The method of claim 1, wherein the plurality of modes are based on one or more of: an audio mode, a text mode, a graphic mode, a multimedia mode, or any combination thereof.

3. The method of claim 2, wherein the audio mode is based on a live voice call or an automated voice call.

4. The method of claim 3, wherein the automated voice call is based on interactive voice response (IVR).

5. The method of claim 2, wherein the text mode is based on one or more of: electronic mail, text messaging, instant messaging, a universal resource locator (URL) message, a session initiation protocol (SIP) message, or any combination thereof.

6. The method of claim 5, wherein text messaging is based on Short Message Service (SMS).

7. The method of claim 2, wherein the multimedia mode is based on one or more of:
Multimedia Messaging Service (MMS), Enhanced Messaging Service (EMS), IP Multimedia System (IMS), audio/video broadcasting, or any combination thereof.

8. The method of claim 1, wherein enabling the user to select the response mode comprises enabling the selected response mode to be embedded in the request message.

9. The method of claim 8, wherein determining the selected response mode based on the request message comprises extracting the selected response mode from the request message.

10. The method of claim 1, wherein enabling the user to select the response mode comprises receiving and storing the selected response mode before receiving the request message.

11. The method of claim 10, wherein determining the selected response mode based on the request message comprises:
identifying the user based on the request message; and
retrieving the selected response mode associated with the user from a database.

12. The method of claim 1, wherein determining the selected response mode based on the request message comprises:
identifying a request mode associated with the request message; and
retrieving the selected response mode based on the request mode from a database.

13. The method of claim 1, wherein the request type is based on one or more of: account information request, news request, market update request, stock quote request, location request, directions request, weather report request, sports report request, new account information request, customer service request, or any combination thereof.

14. A computer program product, tangibly embodied in an information carrier, the computer program product including instructions being operable to cause a data processing apparatus to:
enable a user to select a response mode from a plurality of modes associated with a request type, the response mode defining a representation format of information associated with the request type;
receive a request message from the user, the request message capable of having been transmitted by any one of the plurality of modes, the request message associated with the request type;
determine the selected response mode based on the request message; and
transmit a response message using the selected response mode.

15. A system comprising a multimodal information server adapted to:
enable a user to select a response mode from a plurality of modes associated with a request type, the response mode defining a representation format of information associated with the request type;
receive a request message from the user, the request message capable of having been transmitted by any one of the plurality of modes, the request message associated with the request type;
determine the selected response mode based on the request message; and
transmit a response message using the selected response mode.

16. The system of claim 15, wherein the multimodal information server comprises one or more adaptors for interfacing with one or more servers associated with the plurality of modes.

17. The system of claim 15, wherein the plurality of modes are based on one or more of: an audio mode, a text mode, a graphic mode, a multimedia mode, or any combination thereof.

18. The system of claim 15, wherein the multimodal information server comprises a database adapted to receive and store the selected response mode before the multimodal information server receives the request message.

19. The system of claim 15, wherein the multimodal information server comprises:
a receiver for receiving a request message from the user;
a processor for determining the selected response mode based on the request message; and
a processor memory module for storing the request message.
